(19) United States
(12) Patent Application Publication
(10) Pub. No.: US 2010/0290538 A1
(43) Pub. Date: Nov. 18, 2010

(54) VIDEO CONTENTS GENERATION DEVICE AND COMPUTER PROGRAM THEREFOR

(76) Inventors: Jianfeng XU, Fujimino-shi (JP); Haruhisa Kato, Fujimino-shi (JP); Koichi Takagi, Fujimino-shi (JP); Akio Yoneyama, Fujimino-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/777,782

(22) Filed: May 11, 2010

(30) Foreign Application Priority Data
May 14, 2009 (JP) 2009-117709

(51) Int. Cl. H04N 11/02

(52) U.S. Cl. 375/240.28; 375/E07.026

(57) ABSTRACT

A video contents generation device generates video contents smoothly connecting a series of poses of a human skeleton in conformity with the music with the reduced amount of calculation. The video contents generation device is constituted of a motion analysis unit detecting motion features from motion data representing motion segments of poses, a database storing motion data in connection with subclassification (e.g. genres and tempos), a music analysis unit detecting music features from music data representing the music subjected to the video contents generating procedure, a synchronization unit generating the synchronization information for establishing the correspondence between motion data and music data based on motion features suited to music features, and a video data generation unit generating video data synchronized with music data based on the synchronization information.

### BACKGROUND OF THE INVENTION

1. Field of the Invention

The present invention relates to video contents generation devices and computer programs, and in particular to computer graphics in which objects are displayed in association with a rendition of music.

The present application claims priority on Japanese Patent Application No. 2009-117709, the content of which is incorporated herein by reference.

2. Description of the Related Art

Conventionally, various technologies have been developed with respect to computer graphics (CG) displaying computer-generated objects on screens in association with a rendition of music. Non-Patent Document 1 discloses that when a player gives a rendition of music, CG models move in conformity with predetermined mapping patterns of music. Patent Document 1 discloses reloading of rendering information (e.g. viewpoint information and light-source information) on time-series CG objects based on static attributes or dynamic attributes of music data. Herein, music data are reproduced in synchronization with CG objects displayed on screen. Patent Document 2 discloses a motion generation device creating a directed graph with directed edges between two similar human-body postures in a motion database. Thus, it is possible to select motions by way of the correction of beat features between motion and music.

Non-Patent Document 2 discloses a technique of music analysis in which beat intervals and beat constitutions are detected upon estimating phonetic components, chord modifications, and sound-generation timings of percussion instruments.

Non-Patent Document 3 discloses a technique of motion analysis in which beat intervals and beat constitutions are detected upon estimating variations and timings of motion-beats.

Non-Patent Document 4 discloses a technology for creating new motion data using motion graphs.

Non-Patent Documents 5 and 6 disclose technologies for detecting principal components having a high rate of contribution upon conducting principal component analysis on entire motion data.

Non-Patent Document 7 discloses a dynamic programming technology, which searches for an optimal path derived from a certain start point in a graph.

### [Prior-Art Documents]

Patent Document 1: Japanese Patent Application Publication No. 2005-56101
Patent Document 2: Japanese Patent Application Publication No. 2007-18388
Non-Patent Document 1: Masataka Goto, Youichi Muraoka, “Interactive Performance of a Music-controlled CG Dancer”, Computer Software (Journal of Japan Society for Software Science and Technology), Vol. 14, No. 3, pp. 20-29, May 1997
Non-Patent Document 2: Masataka Goto, “An Audio-based Real-time Beat Tracking System for Music With or Without Drum-sounds”, Journal of New Music Research, Vol. 30, No. 2, pp. 159-171, 2001
Non-Patent Document 3: Tae-hoon Kim, Sang II Park, Sung Yong Shin, “Rhythmic-Motion Synthesis Based on Motion-Beat Analysis”, ACM Transaction on Graphics, Vol. 22, Issue 3, 2003 (SIGGRAPH 2003), pp. 392-401
Non-Patent Document 4: Lucas Kovar, Michael Gleicher, and Frédéric Pighin, “Motion Graphs”, ACM Transaction on Graphics, Vol. 21, Issue 3, 2002 (SIGGRAPH 2002), pp. 473-482
Non-Patent Document 5: Luis Molina Tanco and Adrian Hilton, “Realistic Synthesis of Novel Human Movements from a Database of Motion Capture Examples”, In IEEE Workshop on Human Motion, pp. 137-142, 2000
Non-Patent Document 6: Pascal Glardon, Rona Boulic and Daniel Thalmann, “PCA-based Walking Engine using Motion Capture Data”, In Computer Graphics International, pp. 292-298, 2004
Non-Patent Document 7: Thomas H. Cormen; Charles E. Leiserson, Ronald L. Rivest, Clifford Stein (1990); “Introduction to Algorithms, Second Edition”, MIT Press and McGraw-Hill. ISBN 0-262-03141-8. pp. 323-69

The technology of Non-Patent Document 1 suffers from the limited number of motions and the presetting of mapping patterns of music. Thus, it is difficult to generate motions with a high degree of freedom. It requires expert knowledge to handle the technology of Non-Patent Document 1, which is very difficult for common users to handle. The technology of Patent Document 1 is not practical because of a difficulty in generating CG animations in conformity with music without suitability for time-series CG objects. The technology of Patent Document 2 is not practical because of a difficulty in creating a directed graph with directed edges between two similar human-body postures in a large-scale motion database. For this reason, it is preferable to link motion data which are selected in connection with music subjected to motion-picture production. The technology of Non-Patent Document 4 requires numerous calculations in creating motion graphs and in searching for paths. An original motion constitution is likely to break down upon using motion graphs which are not created in light of the original motion constitution. A transition between a rapid motion and a slow motion likely causes an unnatural or incoherent motion due to abrupt variations of motion.

### SUMMARY OF THE INVENTION

It is an object of the present invention to provide a video contents generation device that is able to generate video contents with a good suitability for music by way of a large-scale motion database. This aims at establishing an appropriate linkage between motion data with the reduced amount of calculations.

It is another object of the present invention to provide a computer program implementing functions of the video contents generation device.

A video contents generation device of the present invention includes a motion analysis unit, a database, a music analysis unit, a synchronization unit, and a video data generation unit. The motion analysis unit detects motion features from motion data. The database stores motion features in connection with subclassification (e.g. genres and tempos). The music analysis unit detects music features from music data representing the music subjected to the video contents generating procedure. The synchronization unit generates the synchronization information based on motion features suited to music features. This establishes the correspondence between motion data and music data. The video data generation unit generates video data synchronized with music data based on the synchronization information.

The motion analysis unit further includes a beat extraction unit, a beat information memory, an intensity calculation unit, an intensity information memory, and a motion graph generation unit. The beat extraction unit extracts beats from motion data so as to calculate tempos. The beat information memory stores the beat information representing beats and tempos of motion data. The intensity calculation unit calculates intensity factors of motion data. The intensity information memory stores the intensity information representing intensity factors of motion data. The motion graph generation unit generates motion graph data based on the beat information and the intensity information. In addition, the database stores motion graph data with respect to each tempo of motion data. The music analysis unit detects beats, tempos, and intensity factors from music data. The synchronization unit generates the synchronization information based on motion graph data suited to tempos of music data. This establishes the correspondence between motion data and music data.

Motion data representing poses defined by relative positions of joints compared to the predetermined root (i.e. a waist joint) in the human skeleton are divided in units of segments. They are subjected to the principal component analysis procedure, the principal component selection procedure, the principal component link procedure, the beat extraction procedure, and the post-processing procedure, thus determining beat timings and beat frames. Motion graph data is configured of nodes (corresponding to beat frames) and edges with respect to each tempo. Adjacent nodes are connected via unidirectional edges, while nodes having a high connectivity are connected via bidirectional edges. Adjacent beat frames are connected via the connection portion interpolated using blending motion data.

Desired motion graph data suited to the temp of the music is selected from among motion graph data which are generated with respect to the genre of the music. Among a plurality of paths directing from start-point nodes to end-point nodes via transit nodes, a minimum-cost path (or a shortest path) is selected as an optimal path directing from an optimal start-point node to an optimal end-point node via optimal transit nodes. Based on the optimal path, the synchronization unit generates the synchronization information upon adjusting frame rates so that beat intervals of motion data can match beat intervals of motion data.

The present invention is also directed to a computer program implementing the functions and procedures of the video contents generation device.

The video contents are generated under consideration of motion features suited to the type of the music based on the synchronization information establishing the correspondence between motion data and music data. Thus, it is possible to smoothly connect video images representing a series of poses (or postures) of a human-skeleton model. In addition, motion features are stored in the database in connection with subclassification (e.g. genres and tempos). Thus, it is possible to significantly reduce the amount of calculation in creating three-dimensional moving pictures.

### BRIEF DESCRIPTION OF THE DRAWINGS

These and other objects, aspects, and embodiments of the present invention will be described in more detail with reference to the following drawings.

FIG. 1 is a block diagram showing the constitution of a video contents generation device according to a preferred embodiment of the present invention.

FIG. 2 is an illustration showing a human-skeleton model used for defining motion data, including a plurality of joints interconnected together via a root.

FIG. 3 is a block diagram showing the internal constitution of a motion analysis unit included in the video contents generation device shown in FIG. 1.

FIG. 4 is an illustration showing a plurality of segments subdividing time-series contents, which are aligned to adjoin together without overlapping in length.

FIG. 5 is an illustration showing a plurality of segments subdividing time-series contents, which are aligned to partially overlap each other in length.

FIG. 6 is a graph for explaining a principal component coordinates link step in which two segments are smoothly linked together in coordinates.

FIG. 7 is a graph for explaining a sinusoidal approximation procedure effected between extreme values of beats in units of segments.

FIG. 8 shows a motion graph configuration.

FIG. 9 shows a motion graph generating procedure.

FIG. 10A is an illustration showing a first blending procedure in a first direction between adjacent nodes of beat frames.

FIG. 10B is an illustration showing a second blending procedure in a second direction between adjacent nodes of beat frames.

FIG. 11 is an illustration showing the details of the first blending procedure shown in FIG. 10A.

FIG. 12 shows the outline of frame rate adjusting processing improving the connectivity of beat frames in synchronized motion compared to unsynchronized motion.

### DESCRIPTION OF THE PREFERRED EMBODIMENT

The present invention will be described in further detail by way of examples with reference to the accompanying drawings.

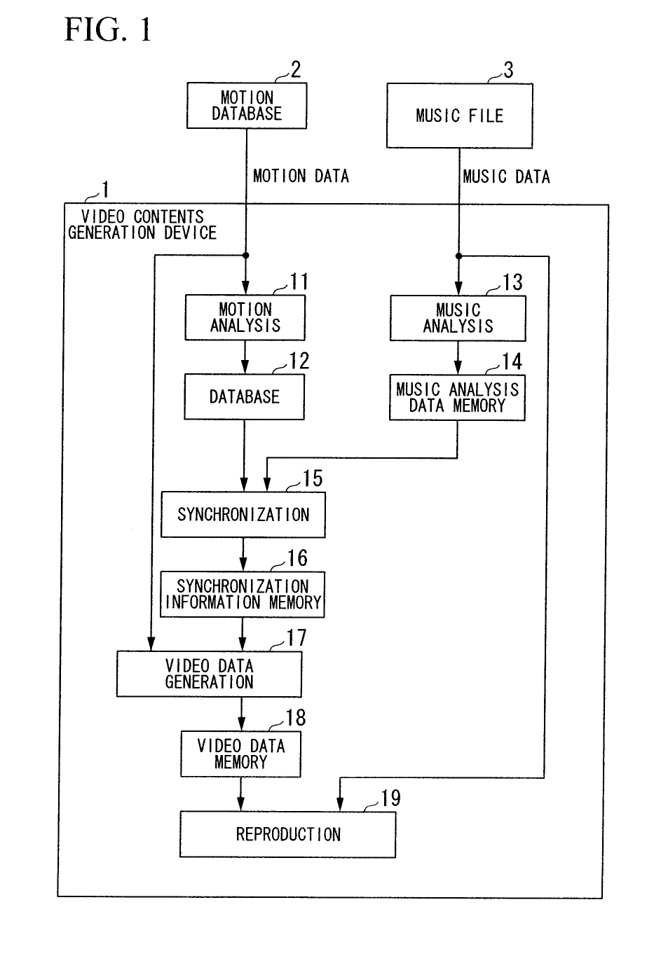

FIG. 1 is a block diagram showing the constitution of a video contents generation device 1 according to a preferred embodiment of the present invention. The video contents generation device 1 is constituted of a motion analysis unit 11, a database 12, a music analysis unit 13, a music analysis data memory 14, a synchronization unit 15, a synchronization information memory 16, a video data generation unit 17, a video data memory 18, and a reproduction unit 19.

The video contents generation device 1 inputs music data representing the music subjected to a video contents generating procedure from a music file 3.

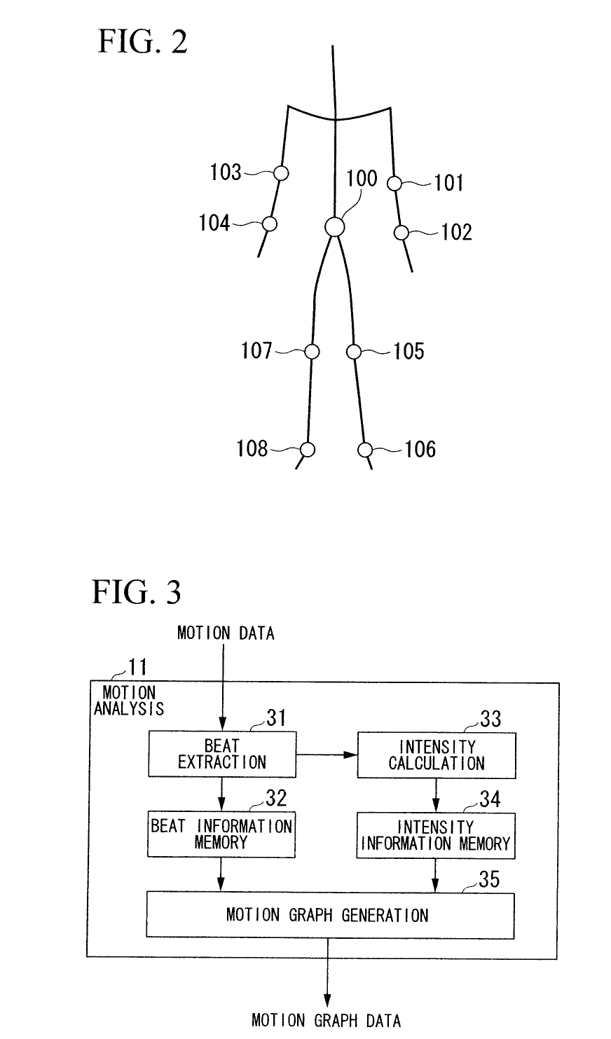

The motion database 2 accumulates numerous motion data which are available in general. The input of video contents generation device 1 is motion data from the motion database 2. The present embodiment handles human motion data of a human skeleton shown in FIG. 2.

FIG. 2 shows a human skeleton used for defining human motion data. Human-skeleton motion data are defined based on a human skeleton including interconnections (e.g. joints) between bones, one of which serves as a root. Herein, a bony structure is defined as a tree structure in which bones are interconnected via joints starting from the root. FIG. 2 shows a partial definition of human-skeleton motion data, wherein a joint 100 denotes a waist serves as a root. Specifically, a joint 101 denotes an elbow of a left-hand; a joint 102 denotes a wrist of the left-hand; a joint 103 denotes an elbow of a right-hand; a joint 104 denotes a wrist of the right-hand; a joint 105 denotes a knee of a left-leg; a joint 106 denotes an ankle of the left-leg; a joint 107 denotes a knee of a right-leg; and a joint 108 denotes an ankle of the right-leg.

Human-skeleton motion data record movements of joints in a skeleton-type object representing a human body, an animal body, and a robot body, for example. Human-skeleton motion data may contain position information and/or angle information of joints, speed information, and/or acceleration information. The following description will be given with respect to human-skeleton motion data containing angle information and/or acceleration information of a human skeleton.

The angle information of human-skeleton motion data includes motion information such as a series of human motions such as human poses and is constituted of neutral pose data (representing a neutral pose or a natural posture of a human body) and frame data (representing poses or postures of human-body motions). Neutral pose data includes various pieces of information representing the position of the root and positions of joints at the neutral pose of a human body as well as lengths of bones. That is, neutral pose data specifies the neutral pose of a human body. Frame data represent moving values (or displacements) from the neutral pose with respect to joints. The angle information is used as moving values. Using frame data, it is possible to specify a certain pose of a human body reflecting moving values from the neutral pose. Human motions are specified by a series of poses represented by frame data. The angle information of human-skeleton motion data is created via motion capture procedures based on video images of human motions captured using video cameras. Alternatively, it is created via the manual operation of key-frame animation.

The acceleration information of human-skeleton motion data represents accelerations of joints of a human body via a series of poses and frame data. The acceleration information of human-skeleton motion data can be recorded using an accelerometer or calculated based on video data or motion data.

In the video contents generation device 1 of FIG. 1, the motion analysis unit 11 inputs human-skeleton motion data (hereinafter, simply referred to as motion data) from the motion database 2 so as to analyze motion data. Thus, it is possible to detect motion features, which are stored in the database 12. The motion analysis unit 11 is able to handle all the motion data accumulated in the motion database 2. The operation of the motion analysis unit 11 is a preparation stage prior to the video contents generating procedure.

FIG. 3 is a block diagram showing the internal constitution of the motion analysis unit 11. The motion analysis unit 11 is constituted of a beat extraction unit 31, a beat information memory 32, a motion intensity calculation unit 33, a motion intensity information memory 34, and a motion graph generation unit 35.

The beat extraction unit 31 detects beat timings from input motion data. Herein, beat timings of motion data represent timings of variations in recursive motion direction or intensity. In the case of a dance, for example, beat timings represent timings of beats in dance music. The beat extraction unit 31 subdivides input motion data into motion segments in short periods. Motion segments are subjected to principal component analysis so as to detect beat timings.

Next, a beat timing detection method according to the present embodiment will be described in detail.

### (1) Feature Extraction Step

In a feature extraction procedure, the beat extraction unit 31 of the motion analysis unit 11 calculates a relative position of each joint compared to the root at time t based on the input motion data.

First, the calculation of the relative position of each joint will be described below.

The joint positions are calculated using neutral pose data and frame data within the angle information of human-skeleton motion data. The neutral pose data are the information specifying the neutral pose, representing the root position and joint positions at the neutral pose of a human skeleton as well as lengths of bones. The frame data are the angle information representing moving values from the neutral pose with respect to joints. A position p^{k}(t) of “Joint k” at time t is calculated via Equations (1) and (2). The position p^{k}(t) is represented by three-dimensional coordinates, wherein time t indicates the timing of frame data. The present embodiment simply handles “time t” as a frame index, wherein time t is varied as 0, 1, 2, . . . , T-1 (where T denotes the number of frames included in motion data).

$$\begin{matrix}{p}^{k} ( t ) = {\prod }_{i = 1}^{k} {M}^{i} ( t ) & ( 1 ) \\ {M}^{i} ( t ) = {R}_{axis}^{i - 1 , i} ( t ) {R}^{i} ( t ) + {T}^{i} ( t ) & ( 2 )\end{matrix}$$

Joint 0 (where i=0) serves as the root. In Equation (2), Rₐₓᵢₛ^{i-1,i}(t) denotes a rotation matrix of coordinates between Joint i and Joint i-1 (i.e. a parent joint of Joint i), which is included in neutral pose data. Local coordinates are assigned to each joint; hence, the rotation matrix of coordinates illustrates the correspondence relationship between local coordinates of parent-child joints. In addition, Rⁱ(t) denotes a rotation matrix of local coordinates of Joint i, which forms the angle information of frame data. Furthermore, Tⁱ(t) denotes a transition matrix between Joint i and its parent joint, which is included in neutral pose data. The transition matrix represents the length of a bone interconnecting between Join I and its parent joint.

Next, a relative position p^{′k}(t) of Join k compared to the root at time t is calculated via Equation (3).

p^{·k}(t)=p^{k}(t)−p^{root}(t) (3)

In Equation (3), p^{root}(t) denotes a position p⁰(t) of the root (i.e. Joint 0) at time t. A frame x(t) at time t is represented as x(t)={p^{′1}(t), p_{′2}(t), . . . , p^{′K}(t)}, where K denotes the number of joints precluding the root.

### (2) Data Subdivision Step

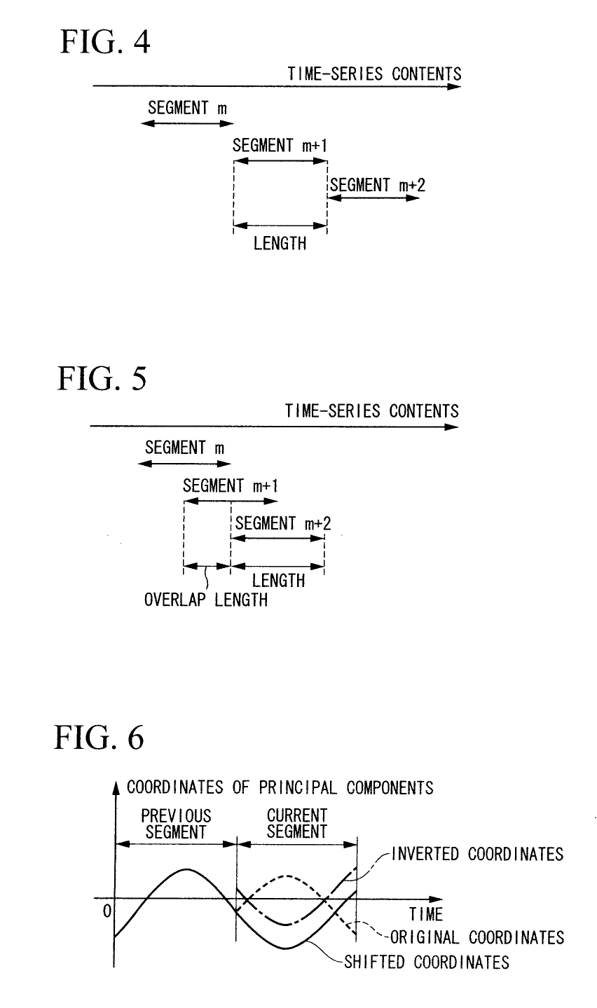

In a data subdivision procedure, the relative position of each joint is subdivided into segments in short periods. Herein, p^{′k}(t) (representing the relative position of each joint) is subjected to a data subdivision procedure, which is illustrated in FIGS. 4 and 5. In the data subdivision procedure, the relative position of each joint is subdivided in units of segments corresponding to a certain number of frames. The length of each segment can be determined arbitrarily. This length is set to sixty frames, for example. FIG. 4 shows that segments do not overlap each other, while FIG. 5 shows that segments partially overlap each other. The overlapped length between adjacent segments can be determined arbitrarily. For example, it is set to a half length of each segment.

### (3) Principal Component Analysis Step

In a principal component analysis procedure, the segments regarding the relative position of each joint subjected to the data subdivision procedure are each subjected to a principal component analysis procedure. Each segment is represented as X={x(t1), x(t2), . . . , x(tN)} (where x(t) denotes a frame at time t). Herein, N denotes the length of each segment (corresponding to the number of frames included in each segment); hence, X denotes a matrix of M rows by N columns (where M=3×K).

In the above, X is transformed into a principal component space in the principal component analysis procedure, which will be described below.

First, a matrix D of N rows by M columns is calculated by precluding an average value from X via Equation (4).

$$D = {( X - \overline{X} )}^{T} \\ \overline{X} = \{ \overline{x} , \overline{x} , … , \overline{x} \} \\ \overline{x} = \frac{1}{N} {\sum }_{i = t 1}^{tN} x ( i ) \qquad ( 4 )$$

Next, the matrix D of N rows by M columns is subjected to singular value decomposition via Equation (5).

D=UΣV^{T} (5)

In Equation (5), U denotes a unitary matrix, and Σ denotes a diagonal matrix having “non-negative” diagonal elements aligned in a descending order in N rows by M columns, indicating variants of coordinates in the principal component space. In addition, V denotes a unitary matrix of M rows by M columns, indicating coefficients of principal components.

Next, the matrix D of N rows by M columns is transformed into the principal component space via Equation (6), where Y is a matrix of M rows by N columns representing coordinates in the principal component space.

Y=(UΣ)^{T} or Y=(DV)^{T} (6)

In the principal component analysis procedure, the matrix Y representing coordinates in the principal component space and the matrix V representing coefficients of principal components are stored in memory.

The matrix X (representing coordinates in the original space) and the matrix Y are interconvertible via Equation (7).

X= X̅+VY (7)

In addition, they are nearly interconvertible via Equation (8) using r elements in the high order of principal components.

\tilde{X}= X̅+V^{r}Y^{r} (8)

In Equation (8), Y^{r} denotes a matrix of M rows by r columns constituted of high-order r elements in the matrix V (representing coefficients of principal components); Y^{r} denotes a matrix of r rows by M columns constituted of high-order r elements in the matrix Y (representing coordinates of principal components); and \tilde{X} represents a restored matrix of M rows by N columns.

It is possible to perform the principal component analysis partially on the degree of freedom of the original space. When beats are designated by only the movements of legs, the matrix X of M rows by N columns is created based on only the relative positions of leg-related joints. Subsequently, the matrix X is subjected to the principal component analysis via Equations (4), (5), and (6).

### (4) Principal Component Selection Step

In a principal component selection procedure, one principal component is selected from the matrix Y (representing coordinates of principal components) with respect to each segment.

The principal component selection procedure will be described with respect to two states.

### (a) First State Where the User Does not Designate a Principal Component

In the first state, the first principal component (i.e. an element in a first row of the matrix Y) is selected from the matrix Y representing coordinates of principal components. The first principal component has a strong relativity in time in each segment. This explicitly indicates motion variations so as to give the adequate information regarding the beat timing.

### (b) Second State Where the User Designates a Principal Component

When the user designates a principal component, the designated principal component is selected from row k the matrix Y representing coordinates of principal components where 1≦k≦K. In the second state, the video contents generation device 1 inputs the designation information of principal components in addition to motion data. It is possible to fixedly determine the designation information of principal components in advance.

The n-th principal component (where n<n≦K) except for the first principal component may be selected when the motion of a part of a human body demonstrates beats, for example. Under the presumption in which a rotating motion of a human body is regarded as the largest motion, the steps of feet on the floor may be regarded as the demonstration of beats. The k-th principal component may give the adequate information regarding the beat timing.

In the principal component selection procedure, the information designating the selected principal component (e.g. the number “k” of the selected principal component where k is an integer ranging from 1 to K) is stored in memory with respect to each segment.

### (5) Principal Component Coordinates Link Step

In a principal component coordinates link procedure, coordinates of principal components are selected in the principal component selection procedure with respect to segments so that they are linked in a time-series manner. That is, coordinates of principal components are adjusted to be smoothly linked together in the boundary between two adjacent segments.

FIG. 6 shows the outline of the principal component coordinates link procedure, in which coordinates of principal components are sequentially linked in a time-series manner starting from the top segment to the last segment. In FIG. 6, coordinates of principal components have been already linked with respect to previous segments; hence, the current segment is now subjected to the principal component coordinates link procedure. In the principal component coordinates link procedure, coordinates of the current segment are adjusted to be smoothly linked to coordinates of the previous segment. Specifically, original coordinates of the current segment, which are selected in the principal component selection procedure, are subjected to sign inversion or coordinate shifting.

Details of the principal component coordinates link procedure will be described via steps S11 to S14.

### (Step S11)

With respect to original coordinates of the current segment selected in the principal component selection procedure (i.e. original coordinates Yₖ of principal component k), a coefficient Vk is retrieved from the matrix V representing coefficients of principal components of the current segment. In addition, another coefficient Vₖ^{pre} is retrieved from the matrix V representing coefficients of principal components of the previous segment stored in memory.

### (Step S12)

Based on the coefficient Vₖ (regarding principal component k of the current segment) and the coefficient Vₖ^{pre} (regarding principal component k of the previous segment), it is determined as to whether or not original coordinates should be subjected to sign inversion via Equation (9). When the result of Equation (9) indicates the sign inversion, the original coordinates Yₖ of principal component k of the current segment are subjected to sign inversion while the matrix V representing coefficients of principal components of the current segment is subjected to sign inversion as well. When the result of Equation (9) does not indicate the sign inversion, both the original coordinates Yₖ of principal component k of the current segment and the matrix V representing coefficients of principal components of the current segment are maintained without being subjected to sign inversion.

$$if across ( {V}_{k} \cdot {V}_{k}^{pre} ) > \frac{π}{2} \\ {Y}_{k}^{′} = - {Y}_{k} \\ {V}^{′} = - V \\ else {Y}_{k}^{′} = {Y}_{k} \\ {V}^{′} = V \qquad ( 9 )$$

In Equation (9), Yₖ denotes original coordinates of principal component k selected in the current segment; V denotes the matrix representing coefficients of principal components of the current segment; Vₖ denotes the coefficient of principal component k of the current segment; Vₖ^{pre} denotes the coefficient of principal component k of the previous segment; “Vₖ·Vₖ^{pre}” denotes the inner product between Vₖ and Vₖ^{pre}; Yₖ′ denotes the result of step S12 with respect to the original coordinates Yₖ of principal component k of the current segment; and V′ denotes the result of step S12 with respect to the matrix V representing coefficients of principal components of the current segment.

### (Step S13)

The resultant coordinates Yₖ′ resulting from step S12 are subjected to coordinates shifting, which will be described in connection with two states.

### (a) First State Where Adjacent Segments do not Overlap Each Other (see FIG. 4)

In the first state, the coordinates shifting is performed via Equation (10), wherein coordinates Yₖ^{pre}(tN) of principal component k of frame tN of the previous segment is produced based on the matrix Y representing coordinates of principal components.

$${Y}_{k}^{″} = {Y}_{k}^{′} + {Y}_{k}^{pre} ( tN ) - {Y}_{k}^{′} ( t 1 ) \\ {Y}_{k}^{opt} ( t 1 ) = \frac{{Y}_{k}^{pre} ( tN ) + {Y}_{k}^{″} ( t 2 )}{2} \qquad ( 10 )$$

In Equation (10), Yₖ′(t1) denotes coordinates of frame t1 within the resultant coordinates Yₖ′ resulting from step S12; and Yₖ″(t2) denotes coordinates of frame t2 within coordinates Yₖ″ produced by a first calculation.

In a second calculation, coordinates Yk″(t1) of frame t1 (which is produced via the first calculation) are replaced with Yₖ^{opt}(t1), thus producing the result of coordinates shifting.

### (b) Second State Where Adjacent Segments Partially Overlap Each Other (see FIG. 5)

In the second state, the coordinates shifting is performed via Equation (11), wherein coordinates Yₖ^{pre}(tN−Lₒₗ+1) of principal component k of frame (tN−Lₒₗ+1) of the previous segment and coordinates Yₖ^{pre}(tN−Lₒₗ+1+i) of principal component k of frame (tN−Lₒₗ+1+i) of the previous segment are calculated based on the matrix Y representing coordinates of principal components of the previous segment, where i=1, 2, . . . , Lₒₗ (where Lₒₗ denotes the overlap length between the previous segment and the current segment).

$${Y}_{k}^{″} = {Y}_{k}^{′} + {Y}_{k}^{pre} ( tN - {L}_{ol} + 1 ) - {Y}_{k}^{′} ( t 1 ) \\ {Y}_{k}^{opt} ( t 1 + i ) = \frac{{Y}_{k}^{pre} ( tN - {L}_{ol} + 1 + i ) + {Y}_{k}^{″} ( t 1 + i )}{2} \qquad ( 11 )$$

In Equation (11), Yₖ′(t1) denotes coordinates of frame t1 within the resultant coordinates Yₖ′ resulting from step S12; and Yₖ″(t1+i) denotes coordinates of frame (t1+i) within the resultant coordinates Yₖ″ produced in a first calculation.

In a second calculation, the coordinates Yₖ″(t1+i) of frame (t1+i) produced in the first calculation are replaced with Yₖ^{opt}(t1+i), thus producing the result of coordinates shifting.

### (Step S14)

The resultant coordinates Yₖ^{opt}(t1) or Yₖ^{opt}(t1+i) resulting from step S13 is incorporated into the resultant coordinates Yₖ′ resulting from step S12 with respect to the current segment. This makes it possible to smoothly link the coordinates of principal components of the current segment to the coordinates of principal components of the previous segment.

The principal component coordinates link procedure is sequentially performed from the first segment to the last segment, thus producing a series of coordinates of principal components “y(t)” (where t=0, 1, 2, . . . , T-1) with respect to all the segments linked together.

### (6) Beat Extraction Step

In a beat extraction procedure, an extreme value b(j) is extracted from the coordinates of principal components y(t) which are calculated with respect to all the segments linked together via the principal component coordinates link procedure. The extreme value b(j) indicates a beat. A beat set B is defined via Equation (12) where J denotes the number of beats.

B={b(j),j=1,2, . . . , J}={t:[y(t)−y(t−1)][y(t)−y(t+1)]>0} (12)

The beat set B is not necessarily created via the above method but can be created via another method. For example, the beat extraction procedure is modified to calculate an autocorrelation value based on coordinates of principal components, which are calculated with respect to all the segments linked together via the principal component coordinates link procedure. Thus, the extreme value b(j) of the autocorrelation value is determined as the representation of a beat.

Alternatively, the beat extraction procedure is modified to calculate an autocorrelation value via the inner product (see Equation (9)) between coefficients of principal components, which are calculated with respect to adjacent segments via the principal component coordinate link procedure. Thus, the extreme value b(j) of the autocorrelation value is determined as the representation of a beat.

### (7) Post-Processing Step

In a post-processing procedure, the beat timing is detected from the beat set B which is produced in the beat extraction procedure.

In a beat timing detection procedure, extreme values of the beat set B are approximated via a sinusoidal curve according to Equation (13).

$${s}_{j - 1} ( t ) = cos ( 2 π \frac{t - b ( j - 1 )}{b ( j ) - b ( j - 1 )} ) \qquad ( 13 )$$

where b(j−1)≦t≦b(j), j=2,3, . . . , J.

In Equation (13), sⱼ₋₁(t) denotes a sinusoidal approximate value between a (j-1)th extreme value b(j-1) and a jth extreme value b(j); t denotes time with respect to frames, where t=0, 1, 2, . . . , T-1; and T denotes the number of frames included in motion data.

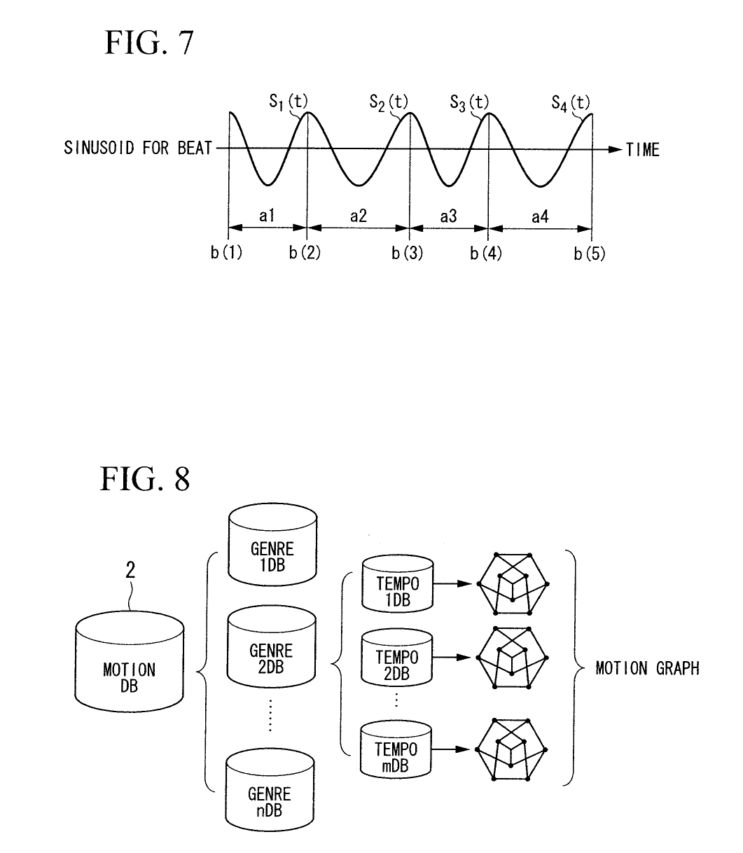

FIG. 7 shows a sinusoidal approximation procedure via Equation (13). That is, a segment a1 (where j=2) between a first extreme value b(1) and a second extreme value b(2) is approximated as s₁(t). A segment a2 (where j=3) between the second extreme value b(2) and a third extreme value b(3) is approximated as s₂(t). A segment a3 (where j=4) between the third extreme value b(3) and a fourth extreme value b(4) is approximated as s₃(t). A segment a4 (where j=4) between the fourth extreme value b(4) and a fifth extreme value b(5) is approximated as s₂(t).

Subsequently, a Fourier transform procedure is performed on the sinusoidal approximation value sⱼ₋₁(t) (where j=2, 3, . . . , J). The Fourier transform procedure is performed via a fast Fourier transform (FFT) operator which uses a Han window of a predetermined number L of FFT points. A maximum-component frequency fmax representing the frequency of a maximum component is detected from a frequency range used for the Fourier transform procedure. Subsequently, a beat interval TB is calculated via an equation of TB=Fs÷fmax, where Fs denotes the number of frames per second.

A maximum-correlation initial phase is calculated via Equation (15) with respect to the sinusoidal approximate value sⱼ₋₁(t) (where j=2, 3, . . . , J) and a reference value s′(t) which is defined as Equation (14).

s′(t)=cos(2πt/TB) (14)

where b(1)≦t≦b(J).

$${φ}^{⋒} = {arg max}_{φ} {\sum }_{t} {s}_{j - 1} ( t ) {s}^{′} ( t + φ ) \qquad ( 15 )$$

where 0≦φ≦TB.

Next, a set EB of a beat timing eb(j) is calculated via Equation (16), where EJ denotes the number of beat timings.

EB={eb(j), j=1,2, . . . , EJ}={\hat{φ}+j*TB} (16)

According to the beat timing detection procedure, the beat extraction unit 31 calculates the set EB of the beat timing eb(j) based on motion data. In addition, the beat extraction unit 31 calculates a motion tempo (i.e. the number of beats per minute) via Equation (17), where the number of frames per second is set to 120, and TB denotes the beat interval.

$${Tempo}^{Motion} = \frac{120 * 60}{TB} \qquad ( 17 )$$

The beat extraction unit 31 stores the motion tempo and the set EB of the beat timing eb(j) in the beat information memory 32 with respect to each motion data. The beat extraction unit 31 also stores the correspondence relationship between the principal component analysis segment (i.e. the segment subjected to the principal component analysis procedure) and the beat timing eb(j) in the beat information memory 32. Thus, it is possible to indicate the beat timing belonging to the principal component analysis segment.

Next, the motion intensity calculation unit 33 calculates the motion intensity information via Equation (18) with respect to each motion data per each principal component analysis segment.

I=tr(Σ) (18)

In Equation (18), Σ denotes a diagonal matrix indicating a descending order of non-negative fixed values, which are produced in the principal component analysis procedure. That is, it represents variances of coordinates of the principal component space. In addition, tr( )denotes a sum of elements of a diagonal matrix, i.e. a matrix trace.

The motion intensity calculation unit 33 stores the motion intensity information in the motion intensity information memory 34 with respect to each motion data per each principal component analysis segment.

Next, the motion graph generation unit 35 generates a motion graph based on the motion tempo, the motion intensity information, and the set EB of the beat timing eb(j) with respect to each motion data. Non-Patent Document 4 shows an example of the motion graph, which is constituted of nodes (or apices), edges (or branches) representing links between nodes, and weights of edges. Two types of edges are referred to as bidirectional edges and unidirectional edges.

FIG. 8 shows a motion graph configuration. Motion data stored in the motion database 2 are classified into various genres, which are determined in advance. Classification of genres is made based on motion features. Each motion data is associated with the genre information assigned thereto. The motion graph generation unit 35 discriminates genres of motion data based on the genre information. In FIG. 8, motion data of the motion database 2 are classified into n genres, namely, genres 1DB, 2DB, . . . , nDB.

The motion graph generation unit 35 subclassifies motion data of the same genre by way of a subclassification factor i according to Equation (19). In FIG. 8, motion data of the genre 2DB is subclassified into m tempo data, namely, tempos 1DB, 2DB, . . . , mDB.

$$i = \frac{{Tempo}^{Motion} - {Tempo}_{min}^{Motion}}{{Q}_{Tempo}} \qquad ( 19 )$$

In Equation (19), Q_{Tempo} denotes a quantization length of tempo; Tempo^{Motion} denotes a tempo with respect to motion data subjected to subclassification; and Tempo^{Motion}ₘᵢₙ denotes a minimum tempo in each genre subjected to subclassification.

The motion graph generation unit 35 generates a motion graph using tempo data which are subclassified using the subclassification factor i with respect to motion data of the same genre.

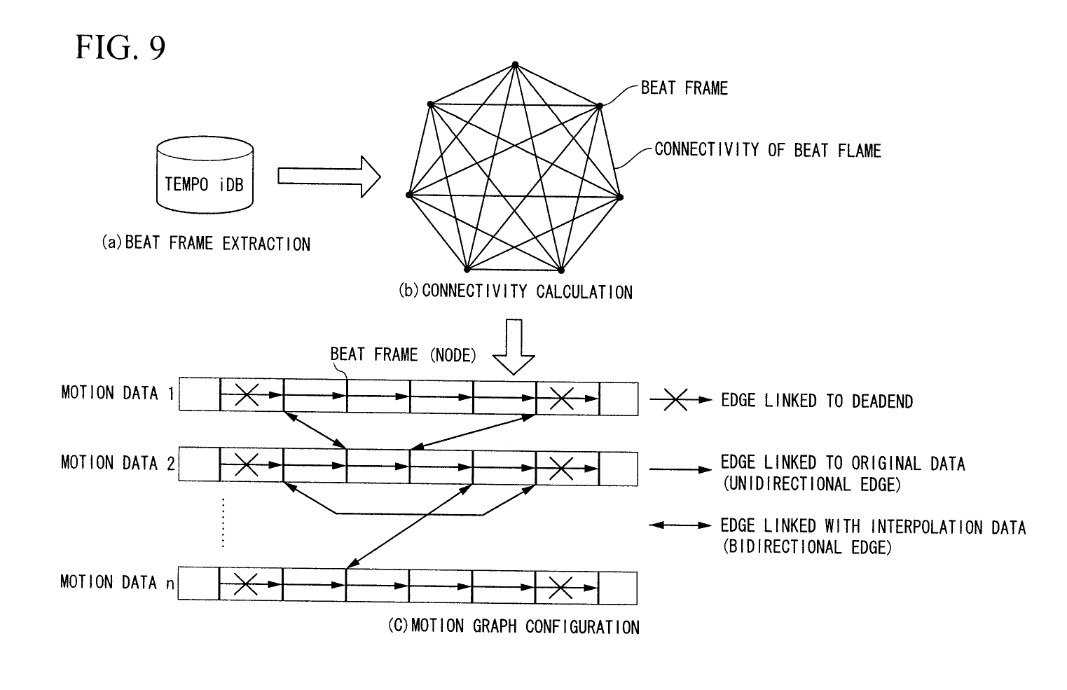

FIG. 9 shows a motion graph generation procedure, in which a motion graph is generated based on motion data regarding tempo data (e.g. tempo iDB) belonging to a certain genre.

### (1) Beat Frame Extraction Step

In a beat frame extraction procedure, beat frames (i.e. frames involved in beat timings) are extracted from all motion data belonging to the tempo iDB, thus creating a set F^{iALL}_{B} of extracted beat frames.

### (2) Connectivity Calculation Step

In a connectivity calculation procedure, a distance between paired beat frames within all beat frames included in the set F^{iALL}_{B} is calculated via Equation (20) or (21), where d(Fⁱ_{B},F^{j}_{B}) denotes the distance between paired beat frames of Fⁱ_{B} and F^{j}_{B}.

$$d ( {F}_{B}^{i} , {F}_{B}^{j} ) = {\sum }_{k} {w}_{k} {‖ log ( {q}_{j , k}^{- 1} {q}_{i , k} ) ‖}^{2} \qquad ( 20 )$$

In Equation (20), q_{i,k} denotes a quaternion of a kth joint of the beat frame Fⁱ_{B}, and wₖ denotes a weight of the kth joint, which is determined in advance.

$$d ( {F}_{B}^{i} , {F}_{B}^{j} ) = {\sum }_{k} {w}_{k} {‖ {p}_{i , k} - {p}_{j , k} ‖}^{2}$$

In Equation (21), p_{i,k} denotes a vector of relative position in a route for the kth joint of the beat frame Fⁱ_{B}. It represents a positional vector of the kth joint of the beat frame Fⁱ_{B} which is calculated without considering the position and direction of the route.

The distance between beat frames can be calculated as the weighted average between differences of physical values regarding positions, speeds, accelerations, angles, angular velocities, and angular accelerations of joints constituting poses in the corresponding beat frames, for example.

Next, a connectivity is calculated via Equation (22), where c(Fⁱ_{B},F^{j}_{B}) denotes the connectivity between paired beat frames of Fⁱ_{B} and F^{j}_{B}.

$$c ( {F}_{B}^{i} , {F}_{B}^{j} ) = \{ \begin{matrix}1 & d ( {F}_{B}^{i} , {F}_{B}^{j} ) < TH * ( d ( {F}_{B}^{i} ) + d ( {F}_{B}^{j} ) ) \\ 0 & d ( {F}_{B}^{i} , {F}_{B}^{j} ) \geq TH * ( d ( {F}_{B}^{i} ) + d ( {F}_{B}^{j} ) )\end{matrix} \qquad ( 22 )$$

In Equation (22), d(Fⁱ_{B}) denotes the distance between a preceding frame and a following frame with respect to the beat frame Fⁱ_{B}, which is calculated via an equation equivalent to Equation (20) or (21); and TH denotes a threshold which is determined in advance.

The connectivity c(Fⁱ_{B},F^{j}_{B})=1 indicates that a similarity is found between the pose of the beat frame Fⁱ_{B} and the pose of the beat frame F^{j}_{B}, while the connectivity c(Fⁱ_{B},F^{j}_{B})=0 indicates that a similarity is not found between the pose of the beat frame Fⁱ_{B} and the pose of the beat frame F^{j}_{B}.

### (3) Motion Graph Configuration Step

In a motion graph configuration procedure, all beat frames included in the set FiALL_{B} are set to nodes of a motion graph; hence, the initial number of nodes included in a motion graph is identical to the number of beat frames included in the set F^{iALL}_{B}.

In the case of c(Fⁱ_{B},F^{j}_{B})=1, a bidirectional edge is formed between the node of the beat frame Fⁱ_{B} and the node of the beat frame F^{j}_{B}. In the case of c(Fⁱ_{B},F^{j}_{B})=0, a bidirectional edge is not formed between the node of the beat frame Fⁱ_{B} and the node of the beat frame F^{j}_{B}.

In addition, a unidirectional edge is formed between adjacent beat frames within the same motion data. The unidirectional edge is directed from the node of the preceding beat frame to the node of the following beat frame with respect to time.

Next, a weight is calculated with respect to the bidirectional edge. Specifically, the weight of the bidirectional edge formed between the node of the beat frame Fⁱ_{B} and the node of the beat frame F^{j}_{B} is calculated as the average between the motion intensity information of the principal component analysis segment corresponding to the beat frame Fⁱ_{B} and the motion intensity information of the principal component analysis segment corresponding to the beat frame F^{j}_{B}.

Next, a weight is calculated with respect to the unidirectional edge. Specifically, the weight of the unidirectional edge formed between the node of the beat frame Fⁱ_{B} and the node of the beat frame F^{j}_{B} by way of a first calculation or a second calculation.

### (a) First Calculation

When both of the beat frames Fⁱ_{B} and F^{j}_{B} belong to the same principal component analysis segment, the motion intensity information of the principal component analysis segment is used as the weight of the unidirectional edge.

### (b) Second Calculation

When the beat frames Fⁱ_{B} and F^{j}_{B} belong to different principal component analysis segments, the average between the motion intensity information of the principal component analysis segment corresponding to the beat frame Fⁱ_{B} and the motion intensity information of the principal component analysis segment corresponding to the beat frame F^{j}_{B} is used as the weight of the unidirectional edge.

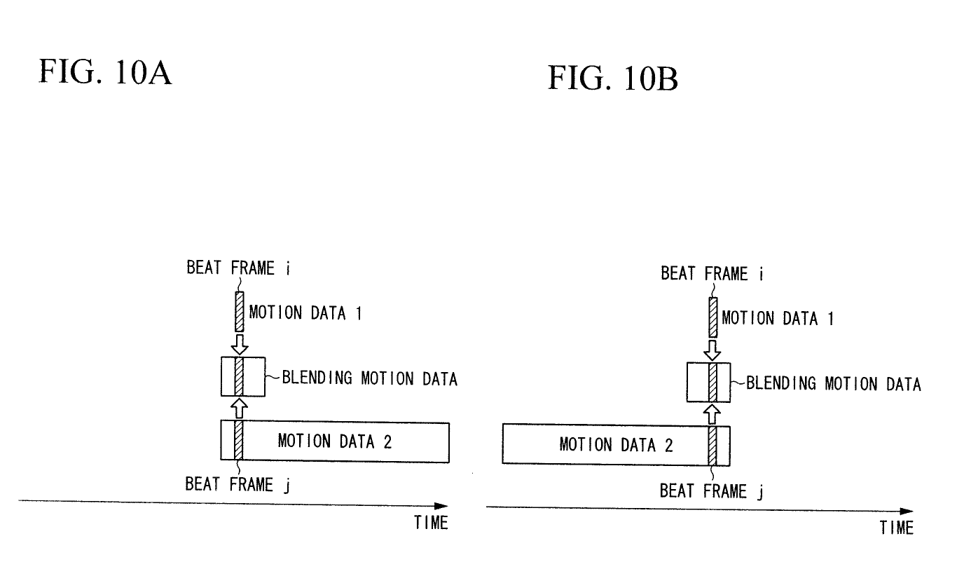

Next, a blending procedure is performed on motion data with regard to nodes (or beat frames) at opposite ends of the bidirectional edge. That is, two blending procedures are performed in two directions designated by the bidirectional edge as shown in FIGS. 10A and 10B. FIGS. 10A and 10B show blending procedures between nodes of beat frames i and j with respect to the bidirectional edge. FIG. 10A shows a first blending procedure in a first direction from the node of the beat frame i to the node of the beat frame j. FIG. 10B shows a second blending procedure in a second direction from the node of the beat frame j to the node of the beat frame i.

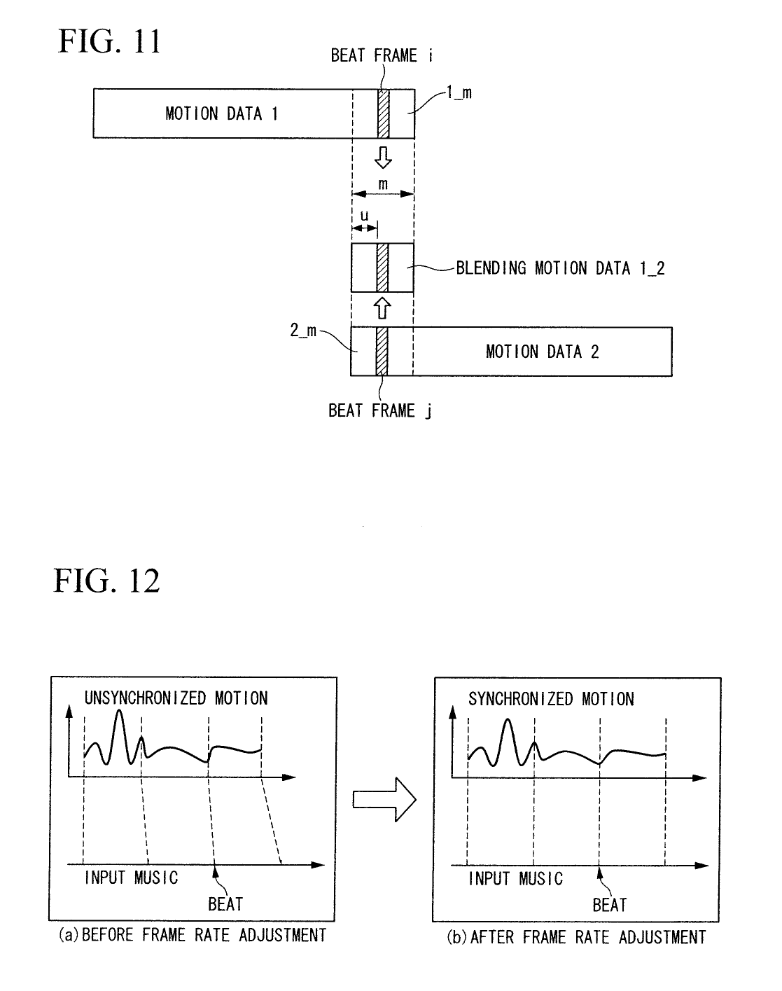

FIG. 11 shows the details of the first blending procedure of FIG. 10A in the first direction from the node of the beat frame i to the node of the beat frame j, which will be described below.

The first blending procedure is performed on motion data 1 of the beat frame i and motion data 2 of the beat frame j so as to form interpolation data (i.e. blending motion data) 1_2 representing a smooth connectivity between motion data 1 and 2 without causing an unnatural or incoherent connectivity between them. The present embodiment is designed to interpolate a connection portion between two motion data by way of a spherical linear interpolation using a quaternion in a certain period of a frame. Specifically, the blending motion data 1_2 regarding the connection portion having a length m (where m is a predetermined value) between motion data 1 and motion data 2 is produced using data 1_{—}m having the length m in the last portion of motion data 1 and data 2_{—}m having the length m in the first portion of motion data 2. According to “u/m”, i.e. a ratio of a distance u (which is measured from the top of the connection portion) to the length m of the connection portion, a part of the frame i corresponding to the distance u in the data 1_{—}m is mixed with a part of the frame j corresponding to the distance u in the data 2_{—}m. Mathematically, blending frames constituting the blending motion data 1_2 is produced via Equations (23) and (24), wherein Equation (23) is drafted with regard to a certain bone in a human skeleton.

q(k,u)=slerp(q(k,i),q(k,j),u/m) (23)

slerp(q(k,i),q(k,j),x)=q(k,i)(q(k,i)⁻¹q(k,j))^{x} (24)

In Equations (23) and (24), m denotes the predetermined number of blending frames constituting the blending motion data 1_{—2}; u denotes the serial number of a certain blending frame counted from the first blending frame (where 1≦u≦m); q(k,u) denotes a quaternion of a k-th bone in a u-th blending frame; q(k,i) denotes a quaternion of the k-th bone in an i-th blending frame; and q(k,j) denotes a quaternion of the k-th bone in a j-th blending frame. Herein, the route is not subjected to blending. In Equation (24), the term “slerp” denotes a mathematical expression of the spherical linear interpolation.

Thus, it is possible to produce the blending data 1_2 representing the connection portion between motion data 1 and motion data 2.

Next, dead-ends are eliminated from the motion graph, wherein dead-ends are each defined as a node whose degree is “1”, and the degree is the number of edges connected to each node. In addition, the input degree is the number of edges input into each node, and the output degree is the number of edges output from each node.

Even when dead-ends are eliminated from the motion graph, there is a possibility that new dead-ends may occur in the motion graph. Hence, elimination of dead-ends is repeated until no dead-end occurs in the motion graph.

The above motion graph configuration procedure produces motion graph data with respect to tempo data (i.e. tempo iDB) regarding a certain genre. The motion graph data includes the information regarding nodes (or beat frames) of the motion graph, the information regarding internode edges (i.e. bidirectional edges or unidirectional edges) and weights of edges, and blending motion data regarding two directions of bidirectional edges.

The motion graph generation unit 35 generates motion graph data with respect to each tempo data regarding each genre, so that motion graph data is stored in the database 12. Thus, the database 12 accumulates motion graph data with respect to tempo data.

The motion analysis unit 11 performs the above procedures in an offline manner, thus creating the database 12. The video contents generation device 1 performs online procedures using the database 12, which will be described below.

The video contents generation device 1 inputs music data (representing the music subjected to the video contents generating procedure) from the music file 3. The music analysis unit 13analizes music data, which is subjected to the video contents generating procedure, so as to extract music features. The present embodiment adopts the foregoing technology of Non-Patent Document 2 to detect music features such as beat intervals, beat timings, and numeric values representing tensions or intensities of music from music data.

The music analysis unit 1 calculates tempos of music via Equation (25), wherein the tempo of music is defined as the number of beats per minute, and TB_{music} denotes the beat interval measured in units of seconds.

$${Tempo}^{Music} = \frac{60}{{TB}_{music}} \qquad ( 25 )$$

The music analysis unit 1 stores music features (e.g. beat intervals, beat timings, tempos, and intensities) in the music analysis data memory 14.

The synchronization unit 15 selects desired motion graph data suited to the music subjected to the video contents generating procedure from among motion graph data of the database 12. That is, the synchronization unit 15 selects motion graph data suited to the tempo of the music subjected to the video contents generating procedure from among motion graph data suited to the genre of the music subjected to the video contents generating procedure. The video contents generation device 1 allows the user to input the genre of the music subjected to the video contents generating procedure. Alternatively, it is possible to determine the genre of the music subjected to the video contents generating procedure in advance.

Specifically, the synchronization unit 15 performs calculations via Equation (15) with respect to the entire tempo of the music and the minimum tempo of motion graph data of the selected genre. Subsequently, the synchronization unit 15 selects motion graph data ascribed to the subclassification factor i calculated in Equation (19) from among motion graph data input by the user or predetermined motion graph data.

Using the selected motion graph data, the synchronization unit 15 generates the synchronization information establishing the correspondence between motion data and music data. A synchronization information generation method will be described below.

### (1) Start Point Selection Step

In a start point selection procedure, node candidates (or start-point candidate nodes), each of which is qualified as a start point of a video-contents motion, is nominated from among nodes of motion graph data. As start-point candidate nodes, it is necessary to choose all nodes corresponding to first beat frames of motion data within nodes of motion graph data. For this reason, the synchronization unit 15 normally nominates a plurality of start-point candidate nodes based on motion graph data.

### (2) Optimal Path Search Step

In an optimal path search procedure, the synchronization unit 15 searches for optimal paths starting from start-point candidate nodes on motion graph data. Thus, it is possible to select a minimum-cost path from among optimal paths. The optimal path search procedure employs the path search technology of Non-Patent Document 7, searching the optimal path starting from a certain start point via dynamic programming. Details of the optimal path search procedure will be described below.

The cost is calculated with respect to each path which starts from a certain start-point candidate node u to reach a node i on motion graph data via Equation (26). A first shortest-path calculating operation is performed with respect to the start-point candidate node u.

shortestPath(i,1)=edgeCost(u,i) (26)

In Equation (26), “shortestPath(i,1)” denotes the cost of the path from the start-point candidate node u to the node i according to the first shortest-path calculating operation; and “edgeCost(u,i)” denotes the cost of the edge from the node u to the node i, wherein the edge cost is calculated via Equation (29).

A second shortest-path calculating operation to a k-th shortest-path calculating operation are each performed via Equation (27) with respect to the cost of the optimal path from the start-point candidate node u to all nodes v on motion graph data.

$$shortestPath ( v , k ) = {min}_{v ∈ V} ( \begin{matrix}shortestPath ( i , k - 1 ) + \\ edgeCost ( i , v )\end{matrix} ) \qquad ( 27 )$$

In Equation (27), V denotes the set of nodes on motion graph data; “shortestPath(v,k)” denotes the cost of the optimal path from the start-point candidate node u to the node v in the k-th shortest-path calculating operation; and “edgeCost(i,v)” denotes the cost of the edge from the node i to the node v.

The above shortest-path calculation operation of Equation (27) is repeated K times. Herein, K denotes the number of beats in the music subjected to the video contents generating procedure. It is equal to the total number of beat timings in the music subjected to the video contents generating procedure. In this connection, the beat timings of the music subjected to the video contents generating procedure are stored in the music analysis data memory 14. Thus, it is possible to read the number K upon counting the beat timings stored in the music analysis data memory 14.

The shortest-path calculating operations of Equations (26) and (27) are repeatedly performed with respect to all the start-point candidate nodes. The synchronization unit 15 determines the minimum-cost path based on the results of the shortest-path calculating operations, which are performed K times with respect to all start-point candidate nodes, via Equation (28).

$$shortestPath ( K ) = {min}_{v ∈ V} ( shortestPath ( v , K ) ) \qquad ( 28 )$$

In Equation (28), “shortestPath(v,k)” denotes the cost of the shortest path from the start-point candidate node u to the node v, which is determined by performing shortest-path calculating operations K times; and “shortestPath(K)” denotes the cost of the minimum-cost path from the start-point node u to the end-point node v.

The edge cost is calculated in each shortest-path calculating operation via Equation (29).

$$edgeCost ( i , j ) = \{ \begin{matrix}‖ \overline{w} ( i , j ) - \overline{I} ( k ) ‖ & if & e ( i , j ) ∈ E \\ ∝ if i = j & or & e ( i , j ) ∉ E\end{matrix} \qquad ( 29 )$$

In Equation (29), “edgeCost(i,j)” denotes the cost of the edge from the node i to the node j; w̅(i, j) denotes the normalized weight of the edge; Ī(k) denotes the normalized intensity factor between the k-th beat and the (k+1)th beat in the music subjected to the video contents generating procedure; e(i,j) denotes the edge between the node i and the node j; and E denotes the set of edges on motion graph data.

The optimal path search procedure determines the optimal path as the minimum-cost path selected via Equation (28). The optimal path includes K nodes constituted of one start-point node u, (K-2) transit nodes i, and one end-point node v. In this connection, the synchronization unit 15 finds out the same number of optimal paths as the number of start-point candidates nodes. That is, the synchronization unit 15 designates the minimum-cost path and its start-point node as the resultant optimal path selected from among a plurality of optimal paths corresponding a plurality of start-point candidate nodes. The resultant optimal path includes K nodes constituted of one optimal start-point node u^{opt}, (K-2) optimal transit nodes i^{opt}, and one optimal end-point node v^{opt}.

### (3) Synchronization Information Generation Step

In a synchronization information generation procedure, the synchronization unit 15 generates the synchronization information establishing the correspondence between motion data and music data in accordance with the resultant optimal path designated by the optimal path search procedure. Details of the synchronization information generation procedure will be described below.

The resultant optimal path includes K nodes (constituted of one optimal start-point node u^{opt}, (K-2) optimal transit nodes i^{opt}, and one optimal end-point node v^{opt}) in correspondence with K beat frames (constituted of one start-point beat frame, (K-2) transit beat frames, and one end-point beat frame). Time intervals and frame rates are calculated between adjacent beat frames in the sequence of the resultant optimal path. In addition, time intervals are calculated between adjacent beats in time with respect to K beats of the music subjected to the video contents generating procedure.

Subsequently, the synchronization unit 15 adjusts beat intervals of motion data to match beat intervals of music data by increasing/decreasing frame rates of motion data via Equation (30). FIG. 12 shows the outline of the processing for adjusting frame rates of motion data. Equation (30) is used to calculate the frame rate between the nth beat frame and the (n+1)th beat frame, where n is a natural number ranging from 1 to K-1.

$$rate\_new = \frac{{t}_{node 2}^{motion} - {t}_{node 1}^{motion}}{{t}_{node 2}^{music} - {t}_{node 1}^{music}} \times rate\_old \qquad ( 30 )$$

In Equation (30), t^{motion}_{node2} denotes the timing of the preceding beat frame, and t^{motion}_{node1} denotes the timing of the subsequent beat frame within adjacent beat frames of motion data. In addition, t^{music}_{node2} denotes the timing of the preceding beat frame, and t^{music}_{node2} denotes the timing of the subsequent beat frame within adjacent beat frames of music data. Furthermore, rate_old denotes the original frame rate, and rate_new denotes the adjusted frame rate.

The synchronization unit 15 implements the synchronization information generation method so as to produce one start-point beat frame (representing the start point of motion in the video contents), one end-point beat frame (representing the end point of motion in the video contents), and (K-2) transit beat frames (interposed between the start-point beat frame and the end-point beat frame) as well as the adjusted frame rates calculated between adjacent beat frames. The synchronization unit 15 integrates the start-point beat frame, the transit beat frames, the end-point beat frame, the adjusted frame rates, and blending motion data (which are interposed between the beat frames) into the synchronization information. The synchronization information is stored in the synchronization information memory 16. The synchronization information may include blending motion data regarding the direction along with the resultant optimal path designated by the optimal path search procedure.

The video data generation unit 17 generates video data and music data representing the music subjected to the video contents generating procedure based on the synchronization information stored in the synchronization information memory 16. That is, the video data generation unit 17 reads motion data, representing a series of motions articulated with the start-point beat frame and the end-point beat frame via the transit beat frames, from the database 2.

Next, the video data generation unit 17 substitutes blending motion data for connection portions connecting between motion data (i.e. bidirectional edges). At this time, the video data generation unit 17 performs parallel translation on the connection portions of motion data in terms of the position and direction of root coordinates. When the root coordinates of each motion data connected with adjacent motion data remain as local coordinates uniquely ascribed to each motion data, connected motion data are not integrated together with respect to root coordinates so that a video image thereof cannot move smoothly. To avoid such a drawback, the present embodiment adjusts the connection portion between motion data in such a way that the root coordinates of subsequent motion data are offset in position in conformity with the last frame of preceding motion data. The connection portion of motion data is interpolated so as to rectify the connected motion data to represent a smooth video image. In addition, the present embodiment adjusts the connection portion of motion data such that the root direction of subsequent motion data is offset in conformity with the last frame of preceding motion data.

The video data generation unit 17 adds the adjusted frame rate of adjacent beat frames to the connected motion data, thus completely generating video data, which are stored in the video data memory 18.

The reproduction unit 19 reproduces the video data of the video data memory 18 together with music data representing the music subjected to the video contents generating procedure. The reproduction unit 19 sets the frame rate of adjacent beat frame in accordance with the frame rate added to video data. Thus, it is possible to reproduce video data and music data whose beats are synchronized with each other. In this connection, the reproduction unit 19 may be disposed independently of the video contents generation device 1.

The video contents generation device 1 of the present embodiment may be configured of the exclusive hardware. Alternatively, the video contents generation device 1 may be implemented in the form of a computer system such as a personal computer, wherein the functions thereof are realized by running programs.

It is possible to provide the video contents generation device 1 with peripheral devices such as input devices (e.g. keyboards and mouse) and display devices (e.g. CRT (Cathode Ray Tube) displays and liquid crystal displays). Peripheral devices are directly connected with the video contents generation device 1. Alternatively, they are linked with the video contents generation device 1 via communication lines.

It is possible to create programs achieving the aforementioned procedures executed in the video contents generation device 1 and to store them in computer-readable storage media. The computer system loads and executes programs of storage media so as to implement the functions of the video contents generation device 1. The term “computer system” may embrace the software (e.g. operation system (OS)) and the hardware (e.g. peripheral devices). The computer system employing the WWW (World Wide Web) browser may embrace home-page providing environments (or home-page displaying environments).

The term “computer-readable storage media” may embrace flexible disks, magneto-optical disks, ROM, rewritable nonvolatile memory such as flash memory, portable media such as DVD (Digital Versatile Disk), and hard-disk units installed in computers. The computer-readable storage media may further embrace volatile memory (e.g. DRAM), which is able to retain program for a certain period of time, installed in computers such as servers and clients receiving and transmitting programs via networks such as the Internet or via communication lines such as telephone lines.

The above programs can be transmitted from one computer (having the memory storing programs) to the other computer via transmission media or via carrier waves. The term “transmission media” used for transmitting programs may embrace networks such as the Internet and communication lines such as telephone lines.

The above programs may be drafted to achieve a part of the functions of the video contents generation device 1. Alternatively, the above programs can be drafted as differential programs (or differential files) which cooperate with the existing programs pre-installed in computers.

The present invention is not necessarily limited to the present embodiment, which can be modified in various ways within the scope of the invention as defined in the appended claims. The present embodiment is designed to handle motion data of human skeletons but can be redesigned to handle motion data of other objects such as human bodies, animals, plants, and other creatures as well as non-living things such as robots. Of course, the present invention can be adapted to three-dimensional contents generating procedures.

What is claimed is:

1. A video contents generation device comprising:
a motion analysis unit detecting motion features from motion data;
a database storing the motion features in connection with subclassification;
a music analysis unit detecting music features from music data representing the music subjected to a video contents generating procedure;
a synchronization unit generating synchronization information based on the motion features suited to the music features, thus establishing correspondence between the motion data and the music data; and
a video data generation unit generating video data synchronized with the music data based on the synchronization information.

2. The video contents generation device according to claim 1, wherein the motion analysis unit includes
a beat extraction unit extracting beats from the motion data, thus calculating a tempo;
a beat information memory storing beat information representing the beat and the tempo of the motion data;
an intensity calculation unit calculating an intensity factor of the motion data;
an intensity information memory storing intensity information representing the intensity factor of the motion data; and
a motion graph generation unit generating motion graph data based on the beat information and the intensity information,
wherein the database stores the motion graph data with respect to each tempo of the motion data,
wherein the music analysis unit detects beat, a tempo, and the intensity information factor from the music data, and
wherein the synchronization unit generates the synchronization information based on the motion graph data suited to the tempo of the music data, thus establishing correspondence between the motion data and the music data.

3. The video contents generation device according to claim 2, wherein the beat extraction unit performs principal component analysis on the motion data in each segment so as to select coordinates of a principal component, thus detecting beat timings.

4. The video contents generation device according to claim 3, wherein the intensity calculation unit produces the sum of non-negative eigenvalues via the principal component analysis in each segment.

5. The video contents generation device according to claim 2, wherein the motion graph generation unit detects beat frames from the motion data so as to calculate a connectivity between the beat frames, so that the motion graph generation unit forms a configuration of the motion graph data including nodes corresponding to the beat frames and edges corresponding to the connectivity between the beat frames.

6. The video contents generation device according to claim 5, wherein the motion graph generation unit classifies the motion database into subgroups based on genre information and further subclassifies the genre into tempo information.

7. The video contents generation device according to claim 5, wherein the motion graph generation unit forms a bidirectional edge between the nodes having a high connectivity and a unidirectional edge between the adjacent nodes.

8. The video contents generation device according to claim 7, wherein blending motion data are generated to interpolate a connection portion between the nodes having the high connectivity by way of spherical linear interpolation using a quaternion with respect to a frame of a certain time period.

9. The video contents generation device according to claim 7, wherein the unidirectional edge applies a continuity of motion between the adjacent beat frames.

10. The video contents generation device according to claim 5, wherein the edge is applied with a weight based on the intensity factor of the motion data.

11. The video contents generation device according to claim 5, wherein the connectivity is calculated based on a similarity of pose formed in the corresponding beat frames.

12. The video contents generation device according to claim 11, wherein the connectivity is calculated based on a weighted average of differences of physical values applied to joints constituting the pose formed in the corresponding beat frames.

13. The video contents generation device according to claim 2, wherein the synchronization unit searches for an optimal path representing the motion features in conformity with the music features of the music data based on the motion graph data.

14. The video contents generation device according to claim 13, wherein the optimal path is selected from among paths whose number corresponds to the number of beats included in the music data.

15. The video contents generation device according to claim 13, wherein the synchronization unit calculates a cost with respect to the optimal path based on the intensity factor of the motion data and the intensity factor of the music data.

16. The video contents generation device according to claim 2, wherein the synchronization information includes a frame rate which is determined to adjust a beat interval of the motion data to match a beat interval of the music data.

17. The video contents generation device according to claim 1, wherein parallel translation is performed on the connection portion of the motion data in terms of the position and the direction of root.

18. The video contents generation device according to claim 1, wherein the database is formed independently of the video contents generating procedure.

19. A computer program implementing a video contents generating procedure, comprising:
analyzing motion data to detect motion features;
storing the motion features in a database in connection with subclassification;
analyzing music data to detect music features;
generating synchronization information based on the motion features suited to the music features, thus establishing correspondence between the motion data and the music data; and
generating video data synchronized with the music data based on the synchronization information.
